(19) United States
(12) Patent Application Publication
(10) Pub. No.: US 2011/0028024 A1
(43) Pub. Date: Feb. 3, 2011

(54) SHIELD-TYPE COMMUNICATION SOCKET

(76) Inventor: Shan-Jui LU, Xizhi City (TW)

Correspondence Address: Guice Patents PLLC, 12647 Galveston Court #302, Manassas, VA, 20112, US

(21) Appl. No.: 12/556,812

(22) Filed: Sep. 10, 2009

(30) Foreign Application Priority Data
Jul. 28, 2009 (TW) 098213817

(51) Int. Cl. H01R 4/26

(52) U.S. Cl. 439/395

(57) ABSTRACT

The present invention relates to a shield-type communication socket, comprises: a housing, a first terminal seat having a plurality of first terminals; a printed circuit board having a plurality of first openings and a plurality of second openings; a plurality of IDC terminals; a second terminal seat; a terminal pressing member; a first pressing cover rotatably pivoted on one side of the housing; and a second pressing cover rotatably pivoted on another side of the housing; accordingly, a cable can be easily received in the communication socket and tightly and electrically connected to the plural IDC terminals and the plural first terminals.

### BACKGROUND OF THE INVENTION

1. Field of the Invention

The present invention relates to a shield-type communication socket, more particularly to a tool-free shield-type communication socket in which a cable can be received therein and tightly and electrically connected to a plurality of insulation displacement connection (IDC) terminals and a plurality of first terminals through a first pressing cover being engaged with a second pressing cover.

2. Description of Related Art

Referring to FIG. 1, which is a schematic exploded view of a conventional shield-type communication socket. As shown in the figure, the shield-type communication socket includes a main body 200, a terminal pusher 210 and two outer covers 220, 230; wherein the socket is connected to a cable 240 through applying forces from two lateral sides at a same plane. The shield-type communication socket has following disadvantages: 1. the two outer covers 220, 230 are two independent components, when the two outer covers 220, 230 are respectively covered on the terminal pusher 210, only half of signal wires are able to be installed in insulation displacement connection (IDC) terminals; and 2. the diameter of the through hole is fixed and can not be adjusted according to the diameter of the cable 240. For example a conventional shield-type cable 240 has eight wires wherein each two are stranded as a pair, then a metal screen layer is covered on the outer side of the four pairs of stranded wires for eliminating electromagnetic interfere; and another type of conventional shield-type cable has a metal screen layer covering on outer ends of each pair of stranded wires then is covered by an integration covering screen, the diameter of this type is larger than the diameter of the cable having only one metal screen layer.

Referring to FIG. 2, which is a schematic exploded view of another conventional shield-type communication socket. As shown in the figure, the U.S. Pat. No. 7,413,464B1, titled “Socket with integrated insulation displacement connection terminals” has disclosed a communication socket, the shield-type communication socket has a main body 300, a terminal pusher 310 and two outer covers 320, 330, wherein the socket is connected to a cable 340 through applying forces from two lateral sides at a same plane. The shield-type communication socket has following disadvantages: 1. the two outer covers 320, 330 are two independent components, when the two outer covers 320, 330 are respectively covered on the terminal pusher 310, only half of signal wires are able to be installed in the IDC terminals; and 2. the diameter of the through hole 312 is fixed and can not be adjusted according to the diameter of the cable 340.

### SUMMARY OF THE INVENTION

One object of the present invention is to provide a shield-type communication socket, in which plural IDC terminals are able to pierce conduction wires and be in communication with plural first terminals through a first pressing cover and a second pressing cover applying single-plane uniform forces on plural convex bumps.

Another object of the present invention is to provide a shield-type communication socket, in which a mobile latching pin is installed for dynamically adjusting space according to the diameter of a cable.

For achieving the mentioned objects, a shield-type communication socket is provided by the present invention, comprises: a housing having a connection orifice at one end for receiving a connector; a first terminal seat installed in the housing and having a plurality of first terminals being electrically connected to terminals installed on the connector; a printed circuit board installed on one side of the first terminal seat and having a plurality of first openings and a plurality of second openings, the plural first openings are served to let the plural first terminals to be inserted and fastened; a plurality of insulation displacement connection (IDC) terminals installed on one side of the printed circuit board, one end of each of the IDC terminals is respectively inserted and fastened in the plural second openings; a second terminal seat installed on one side of the plural IDC terminals and having a plurality of insertion slots for respectively receiving the plural IDC terminals; a terminal pressing member installed on one side of the second terminal seat and having a through hole, a plurality of clamping slots and a plurality of pressing slots, the through hole is served to let a cable pass through, the plural clamping slots are corresponding to the plural insertion slots; a first pressing cover rotatably pivoted on one side of the housing and having an arc-shaped breach, a fastening member is outwardly extended from one end of the arc-shaped breach, two ends of the fastening member are installed with two guiding slots and a mobile latching pin capable of moving between the two guiding slots is installed; and a second pressing cover rotatably pivoted on the other side of the housing and having an arc-shaped protruding capable of being combined with the arc-shaped breach for receiving the cable.

### BRIEF DESCRIPTION OF THE DRAWINGS

FIG. 1 is a schematic exploded view of a conventional shield-type communication socket;

FIG. 2 is a schematic exploded view of another conventional shield-type communication socket;

FIG. 3 is a schematic front exploded view of the shield-type communication socket of one preferred embodiment of the present invention;

FIG. 4 is a schematic rear exploded view of the shield-type communication socket of one preferred embodiment of the present invention;

FIG. 5 is a schematic front view illustrating the first pressing cover and the second pressing cover of one preferred embodiment of the present invention being combined with the housing and being in an opened status;

FIG. 6 is a schematic rear view illustrating the first pressing cover and the second pressing cover of one preferred embodiment of the present invention being combined with the housing and being in an opened status;

FIG. 7 is a schematic front view illustrating the first pressing cover and the second pressing cover of one preferred embodiment of the present invention being combined with the housing and being in a closed status;

FIG. 8 is a schematic rear view illustrating the first pressing cover and the second pressing cover of one preferred embodiment of the present invention being combined with the housing and being in a closed status;

FIG. 9 is a schematic view illustrating the shield-type communication socket of the present invention being connected to a cable.

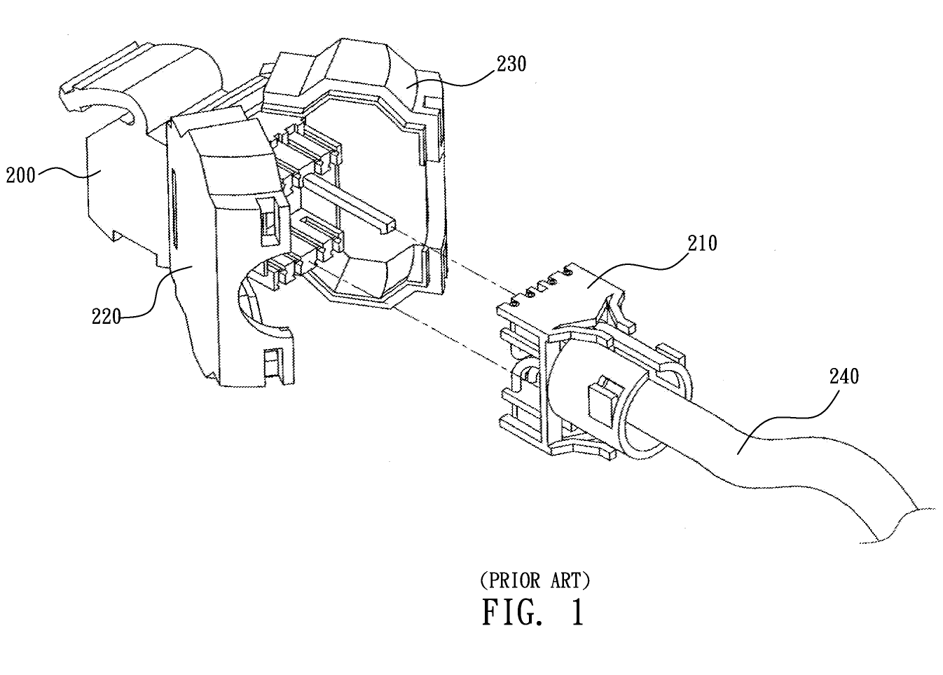

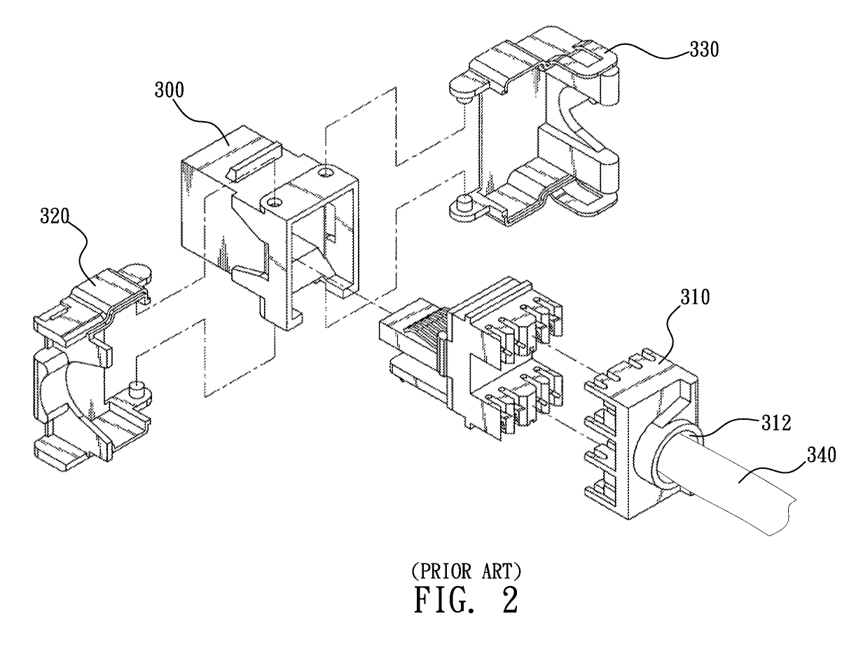

### DETAILED DESCRIPTION OF THE PREFERRED EMBODIMENT

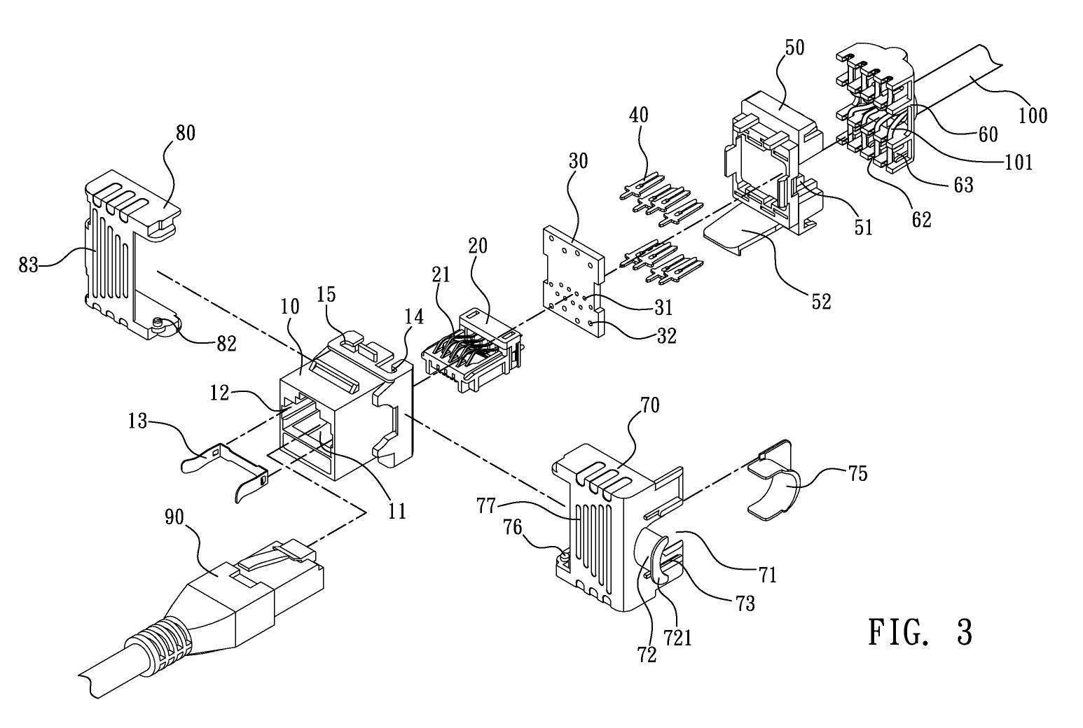

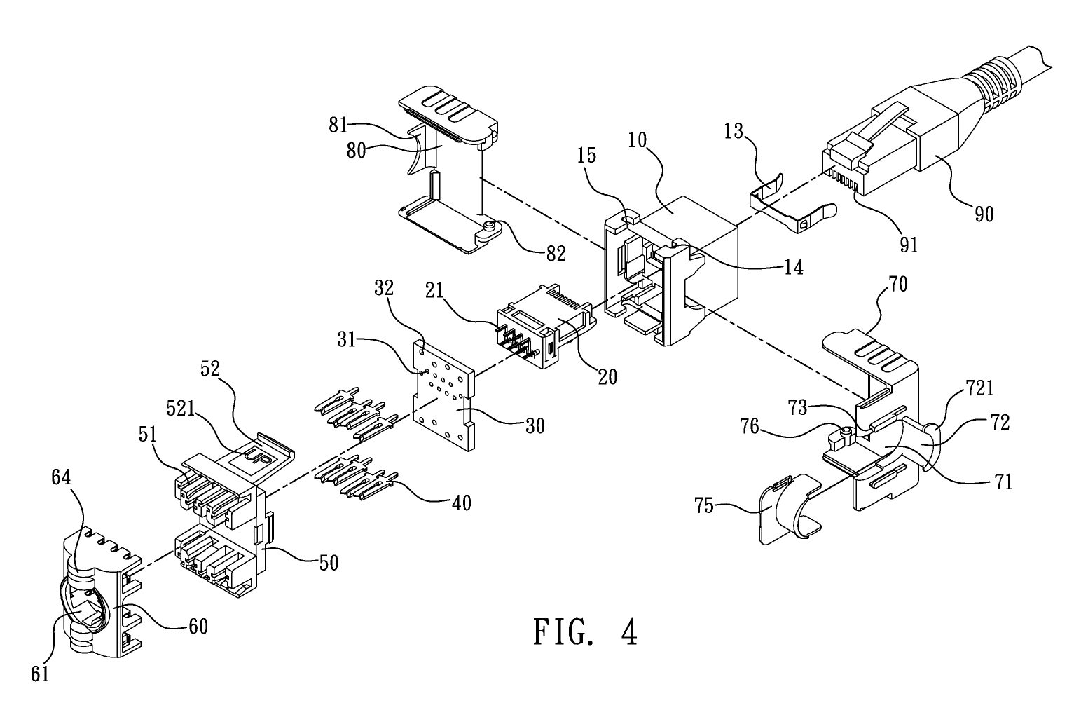

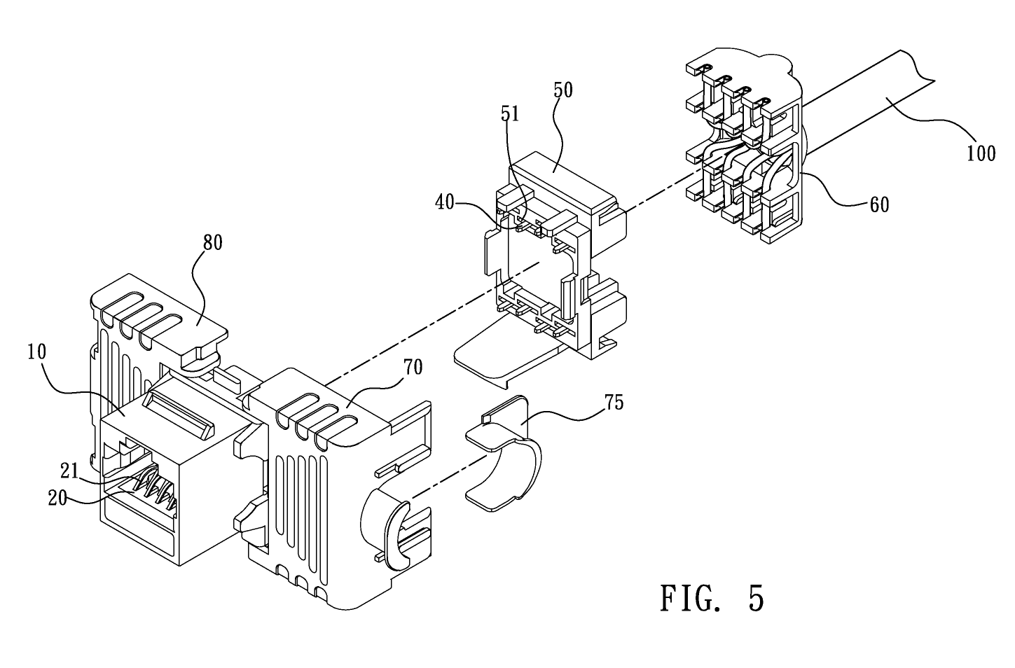

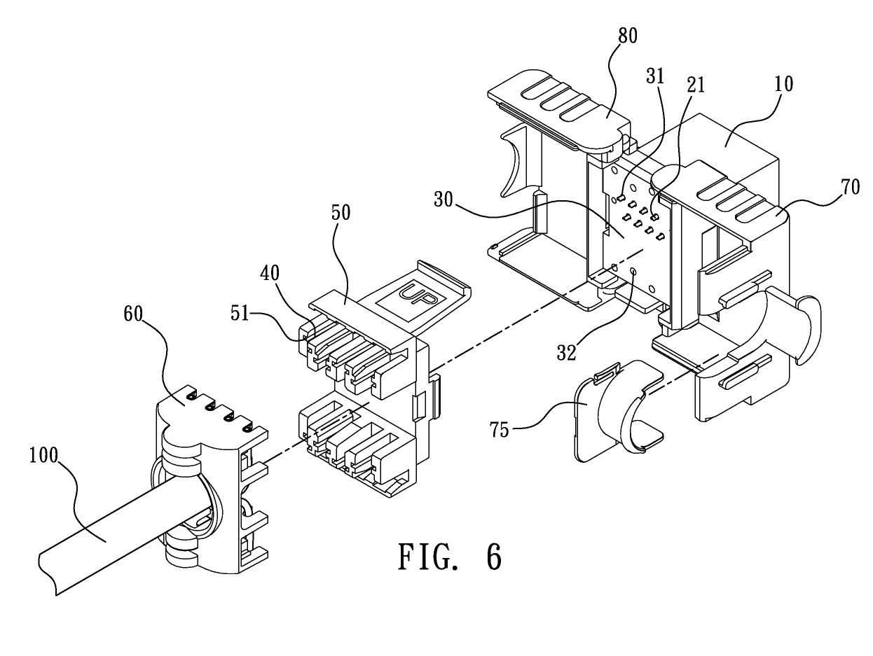

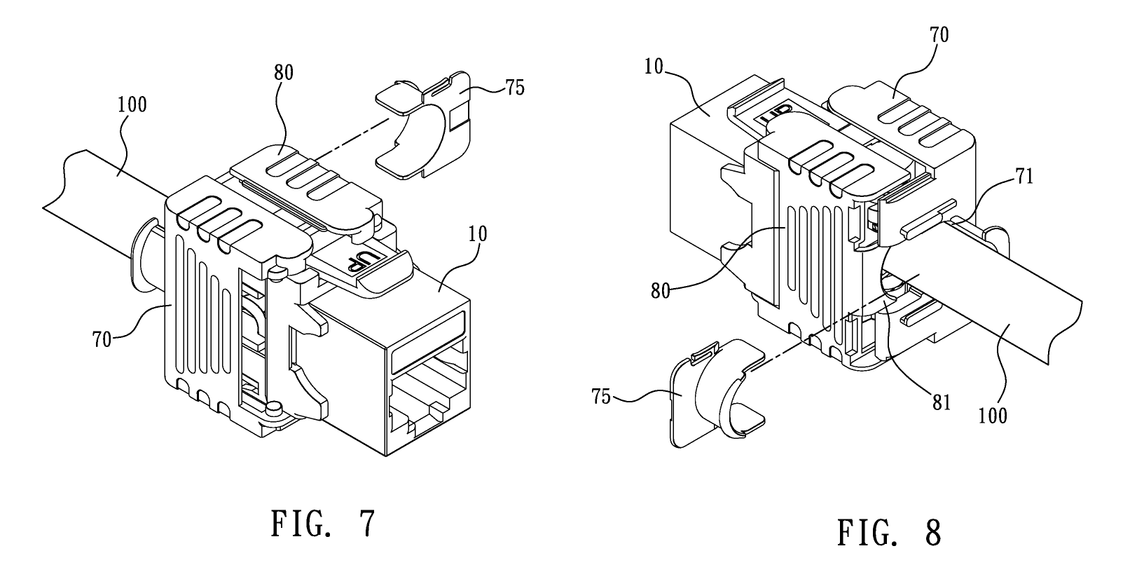

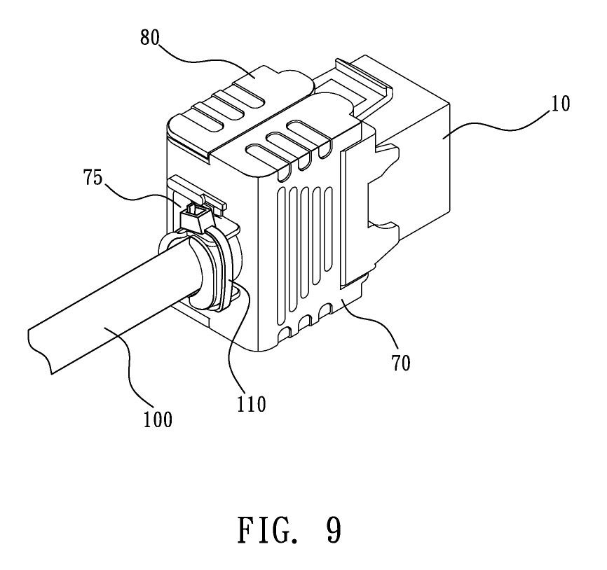

Referring from FIG. 3 to FIG. 9, wherein FIG. 3 is a schematic front exploded view of the shield-type communication socket of one preferred embodiment of the present invention; FIG. 4 is a schematic rear exploded view of the shield-type communication socket of one preferred embodiment of the present invention; FIG. 5 is a schematic front view illustrating the first pressing cover and the second pressing cover of one preferred embodiment of the present invention being combined with the housing and being in an opened status; FIG. 6 is a schematic rear view illustrating the first pressing cover and the second pressing cover of one preferred embodiment of the present invention being combined with the housing and being in an opened status; FIG. 7 is a schematic front view illustrating the first pressing cover and the second pressing cover of one preferred embodiment of the present invention being combined with the housing and being in a closed status; FIG. 8 is a schematic rear view illustrating the first pressing cover and the second pressing cover of one preferred embodiment of the present invention being combined with the housing and being in a closed status; FIG. 9 is a schematic view illustrating the shield-type communication socket of the present invention being connected to a cable.

As shown in figures, the shield-type communication socket provided by the present invention, more particularly to a tool-free shield-type communication socket suitable to be used with a shield-type cable for high speed network, e.g. but not limited to CAT5 or CAT 6 of an Ethernet network, the transferring speed is up to 250 MHz, comprises: a housing 10: a first terminal seat 20; a printed circuit board 30; a plurality of IDC terminals 40; a second terminal seat 50; a terminal pressing member 60; a first pressing cover 70; and a second pressing cover 80.

The housing 10 is in a rectangular shape and made of metal material, e.g. but not limited to iron, one end thereof is installed with a connection orifice 11 for receiving a connector 90, e.g. but not limited to a RJ45 connector, having a plurality of terminals 91. Two ends of the housing 10 are respectively installed with a slot 12. The housing 10 is further provided with a tightening member 13 received in the slots 12 for reinforcing the tight connection between the housing 10 and the connector 90.

The top and the bottom ends of the housing 10 are respectively installed with a first buckling portion 14 and a second buckling portion 15 so as to be respectively buckled with the first pressing cover 70 and the second pressing cover 80.

The first terminal seat 20 is installed in the housing 10 and has a plurality of first terminals 21 that are electrically connected to the terminals 91 of the connector 90, and one end of each of the first terminals 21 is bended to form a resilient sheet, the other end thereof is installed and fastened on the printed circuit board 30.

The printed circuit board 30 is installed on one side of the first terminal seat 20, e.g. but not limited to the left side, and is provided with a plurality of first openings 31 and a plurality of second openings 32; wherein the plural first openings 31 are served to let the plural first terminals 21 to be inserted and fastened. The printed circuit board 30 is further provided with circuits (not shown) for connecting the plural first terminals 21 to the plural IDC terminals 40.

The plural IDC terminals 40 are installed on one side of the printed circuit board 30, e.g. but not limited to the right side, one end of each of the IDC terminals 40 is respectively inserted and fastened in the plural second openings 32.

The second terminal seat 50 is installed on one side of the plural IDC terminals 40, e.g. but not limited to the right side, and is installed with a plurality of insertion slots 51 for respectively receiving the plural IDC terminals 40. The second terminal seat 50 is further extended with a tongue sheet 52 at an end opposite to the end where the plural insertion slots 51 are installed, and the tongue sheet 52 is exposed out of the housing 10 and is further installed with a direction indicating sign 521, e.g. but not limited to an UP sigh, for indicating the direction of the socket.

The terminal pressing member 60 is installed on one side of the second terminal seat 50, e.g. but not limited to the right side, and is installed with a through hole 61, a plurality of clamping slots 62 and a plurality of pressing slots 63, wherein the through hole 61 is served to let a cable 100 pass through, the cable 100 has a plurality of conduction wires 101; the plural clamping slots 62 are corresponding to the plural insertion slots 51 and served to clamp the conduction wires 101. The numbers of installed units of the quantities of the plural first terminals 21, the plural first openings 31, the plural second openings 32, the plural IDC terminals 40, the plural insertion slots 51, the plural clamping slots 62, the plural pressing slots 63 and the plural conduction wires 101 are all eight, which is a conventional art and will not be further illustrated. An end of the terminal pressing member 60 opposite to the end where the plural clamping slots 62 and the plural pressing slots 63 are installed is further provided with a plurality of convex bumps 64, the quantities thereof is e.g. but not limited to four, and the plural convex bumps 64 are uniformly disposed on two ends of the through hole 61.

The first pressing cover 70 is rotatably pivoted on one side of the housing 10, e.g. but not limited to the left side, and has an arc-shaped breach 71, a fastening member 72 is outwardly extended from one end of the arc-shaped breach 71 and two ends of the fastening member 72 are installed with two guiding slots 73 and a mobile latching pin 75 capable of moving between the two guiding slots 73 for dynamically adjusting the space defined between the fastening member 72 and the mobile latching pin 75, and the distal end of the fastening member 72 is outwardly extended with a blocking sheet 721 for blocking and fastening a cable tie 110. The top and the bottom ends of the first pressing cover 70 are installed with a first protruding portion 76 with respect to the first buckling portion 14, so that the first pressing cover 70 is able to be rotatably pivoted on one side of the housing 10 through the first protruding portion 76 being connected to the first buckling portion 14. The first pressing cover 70 is further installed with a plurality of anti-slippery slots 77 for increasing the friction during operation.

The second pressing cover 80 is rotatably pivoted on another side of the housing 10, e.g. but not limited to the right side, and has an arc-shaped protruding 81 capable of being combined with the arc-shaped breach 71 for receiving the cable 100. The top and the bottom ends of the second pressing cover 80 are installed with a second protruding portion 82 with respect to the second buckling portion 15 for respectively buckling on the housing 10, so that the second pressing cover 80 is able to be rotatably pivoted on another side of the housing 10 through the second protruding portion 82 being connected to the second buckling portion 15. The second pressing cover 80 is further installed with a plurality of anti-slippery slots 83 for increasing the friction during operation.

As shown in FIG. 5 and FIG. 6, when being assembled, the plural first terminals 21 of the first terminal seat 20 are respectively inserted and fastened in the plural first openings 31 of the printed circuit board 30; then the first terminal seat 20 and the printed circuit board 30 are disposed inside the housing 10; the plural IDC terminals 40 are respectively fastened in the plural insertion slots 51 of the second terminal seat 50, the first terminals 21 are respectively inserted and fastened in the plural first openings 31 then are respectively inserted and fastened in the plural second openings 32 of the printed circuit board 30; the first pressing cover 70 is pivoted on the left side of the housing 10 and the second pressing cover 80 is pivoted on the right side of the housing 10, the assembly of the shield-type communication socket of the present invention is finished. As shown in FIG. 7 and FIG. 8, when the shield-type communication socket of the present invention is in a closed status, the first pressing cover 70 and the second pressing cover 80 can be engaged so that the arc-shaped protruding 81 and the arc-shaped breach 71 are combined to form a circle for receiving the cable 100, lastly the mobile latching pin 75 is introduced in the guiding slots 73 and moved for dynamically adjusting the space defined between the fastening member 72 and the mobile latching pin 75.

As shown in FIG. 9, when the shield-type communication socket of the present invention is connected with the cable 100, the plural conduction wires 101 of the cable 100 are respectively installed in the plural clamping slots 62 of the terminal pressing member 60; then the plural clamping slots 62 of the terminal pressing member 60 are aimed at the plural insertion slots 51 of the second terminal seat 50 and are tightened through applying forces, so that the plural conduction wires 101 are pressed in the plural insertion slots 51 through the plural pressing slots 63; then the first pressing cover 70 and the second pressing cover 80 are engaged, so that, through the first pressing cover 70 and the second pressing cover 80 applying single-plane uniform forces on the plural convex bumps 64, so the plural IDC terminals 40 are able to pierce the conduction wires 101 and be in communication with the plural first terminals 21, and the arc-shaped protruding 81 and the arc-shaped breach 71 are combined to form a circle for receiving the cable 100; the mobile latching pin 75 is introduced in the guiding slots 73 and moved for dynamically adjusting the space defined between the fastening member 72 and the mobile latching pin 75, lastly the fastening member 72, the mobile latching pin 75 and the cable 100 are bound and tightened by the cable tie 110, and the cable tie 110 is blocked and fastened by the blocking sheet 721. So the connection between the shield-type communication socket of the present invention and the cable is obtained. Therefore the shield-type communication socket of the present invention is novel compared to conventional shield-type communication sockets.

As mentioned above, through the first pressing cover and the second pressing cover applying single-plane uniform forces on the plural convex bumps, the plural IDC terminals are able to pierce the conduction wires and be in communication with the plural first terminals; and the mobile latching pin is provided for dynamically adjusting space according to the diameter of the cable. Therefore the shield-type communication socket of the present invention is novel compared to conventional shield-type communication sockets.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A shield-type communication socket, comprising:
a housing having a connection orifice at one end for receiving a connector;
a first terminal seat installed in the housing and having a plurality of first terminals being electrically connected to terminals installed on the connector;
a printed circuit board installed on one side of the first terminal seat and having a plurality of first openings and a plurality of second openings, the plural first openings are served to let the plural first terminals to be inserted and fastened;
a plurality of IDC terminals installed on one side of the printed circuit board, one end of each of the IDC terminals is respectively inserted and fastened in the plural second openings;
a second terminal seat installed on one side of the plural IDC terminals and having a plurality of insertion slots for respectively receiving the plural IDC terminals;
a terminal pressing member installed on one side of the second terminal seat and having a through hole, a plurality of clamping slots and a plurality of pressing slots, the through hole is served to let a cable pass through, the plural clamping slots are corresponding to the plural insertion slots;
a first pressing cover rotatably pivoted on one side of the housing and having an arc-shaped breach, a fastening member is outwardly extended from one end of the arc-shaped breach, two ends of the fastening member are installed with two guiding slots and a mobile latching pin capable of moving between the two guiding slots is installed; and
a second pressing cover rotatably pivoted on the other side of the housing and having an arc-shaped protruding capable of being combined with the arc-shaped breach for receiving the cable.

2. The shield-type communication socket according to claim 1, wherein the housing is made of metal material, and two ends thereof are respectively installed with a slot.

3. The shield-type communication socket according to claim 2, wherein a tightening member is further installed and received in the slots for reinforcing the tight connection between the housing and the connector.

4. The shield-type communication socket according to claim 1, wherein one end of each of the plural first terminals is bended to form a resilient sheet, the other end thereof is inserted and fastened on the printed circuit board through the plural first openings.

5. The shield-type communication socket according to claim 1, wherein the numbers of installed units of the plural first terminals, the plural first openings, the plural second openings, the plural IDC terminals, the plural insertion slots, the plural clamping slots and the plural pressing slots are all eight.

6. The shield-type communication socket according to claim 1, wherein the top and the bottom ends of the housing are respectively installed with a first buckling portion and a second buckling portion for respectively buckling with the first pressing cover and the second pressing cover.

7. The shield-type communication socket according to claim 6, wherein the top and the bottom ends of the first pressing cover are respectively installed with a first protruding portion with respect to the first buckling portion, the top and the bottom ends of the second pressing cover are respectively installed with a second protruding portion with respect to the second buckling portion so that the first and the second pressing covers are respectively buckled on the housing.

8. The shield-type communication socket according to claim 6, wherein the second terminal seat is further extended with a tongue sheet at an end opposite to the end where the plural insertion slots are installed, and the tongue sheet is exposed out of the housing and is further installed with a direction indicating sign.

9. The shield-type communication socket according to claim 1, wherein an end of the terminal pressing member opposite to the end where the plural clamping slots and the plural pressing slots are installed is further provided with a plurality of convex bumps that are uniformly disposed on two ends of the through hole.

10. The shield-type communication socket according to claim 1, wherein the first pressing cover and the second pressing cover are further provided with anti-slippery slots.

11. The shield-type communication socket according to claim 1, wherein a distal end of the fastening member is outwardly extended with a blocking sheet for blocking and fastening a cable tie.
